(19) United States
(12) Patent Application Publication
(10) Pub. No.: US 2009/0146864 A1
(43) Pub. Date: Jun. 11, 2009

(54) Loran-based underground geolocation, navigation and communication system

(76) Inventors: Paul A. Zank, Brookline, NH (US); David W. Buchanan, Brookline, NH (US)

Correspondence Address: BAE SYSTEMS, PO BOX 868, NASHUA, NH, 03061-0868, US

(21) Appl. No.: 11/660,248

(22) PCT Filed: Apr. 3, 2006
(86) PCT No.: PCT/US06/12295

§ 371 Date: Feb. 13, 2007

Related U.S. Application Data
(60) Provisional application No. 60/685,747, filed on May 27, 2005.

(51) Int. Cl. G01S 3/02

(52) U.S. Cl. 342/22; 342/388

(57) ABSTRACT

A system is provided for underground mapping, location determination and communications utilizing existing LORAN transmitters and a subterranean H-field antenna coupled to a conventional LORAN receiver. The result is an underground LORAN grid from which mapping and location can be ascertained as well as terrestrial-to-subterranean communications using the LORAN bit streams. Subterranean-to-terrestrial communication is established by a low-frequency handheld transmitter using repeat processing to transmit digital data from the subterranean location to the surface of the earth using modulated H-field waves.

### RELATED APPLICATIONS

This Application claims rights under 35 USC § 119(e) from U.S. Application Ser. No. 60/685,747 filed May 27, 2005, the contents of which are incorporated herein by reference.

### FIELD OF THE INVENTION

This invention relates to geolocation, navigation and communication systems and more particularly to the utilization of LORAN signals to determine underground geolocation and to permit bidirectional communication from subterranean locations to the surface of the earth.

### BACKGROUND OF THE INVENTION

Mapping of caves, mines and deep urban environments is conventionally accomplished by dead reckoning or through the use of inertial reference systems to record a path through the subterranean structure as it is being explored. However, dead reckoning and other methods lead to inaccurate and difficult-to-use maps, primarily because the inertial reference system utilized to map out a subterranean structure has significant drift such that when the user retraces his or her path, the drift is likely to record an inaccurate position indicating the operator is in a new part of the cave or mine when in reality the individual is at the same place that he was at an earlier time.

In addition to the inability to provide a system that is useful in navigation in subterranean areas, there is also the problem of communication with an individual in, for instance, a cave or mine due primarily to the attenuation of HF or VHF radio signals that are attenuated in the rock and earth that surround the individual. While mines sometimes provide communications systems that are hard wired or have repeaters, many underground facilities, caves or mines are not fully outfitted with such communications systems and if a problem exists with an individual at an underground location, his or her status or problem cannot be easily ascertained at the earth's surface.

It will be appreciated that in subterranean caves, mines and the like, these are GPS-denied areas in which GPS is not available. While GPS repeaters have been utilized in the vicinity of the opening of a cave or mine, range is limited.

Moreover, if a person in a cave, mine or subterranean environment gets lost or if they find something in a cave or mine and cannot find their way back to where the object is located; or if they cannot tell someone else where they are or how to get to the particular object, then there is no way to ascertain where the person or object is, both because the subterranean passageways are not well-mapped and because there is no way to effectively with repeatable precision communicate one's subterranean location to the surface of the earth even if accurate maps existed.

For mines and the like, it is common knowledge that individuals do not know exactly where they are, primarily because they do not know where the shafts, winzes, passageways, drifts, stopes, chutes, crosscuts, manways, raises, pillars and outreaches are located with respect to the surface of the earth. The reason, as stated before, is that dead reckoning does not work very well for underground mapping purposes because of the many bends and curves of these passageways. This means that trying to survey the passageways, tunnels or the like by conventional means is error-prone.

There are in fact some mines, such as the early coal mines in Pennsylvania, which were never mapped and if a fire or some accident occurs, those running the mines have no idea where the fire is going to or how the dangerous condition might propagate within the mine.

Since high-frequency communications do not penetrate into the earth more than a couple of centimeters due to the fact that the E-field in these HF or VHF communications is greatly attenuated, any attempt at using HF communications to solve the mapping problem fails.

There is therefore an urgent need to be able to map subterranean areas such as mines, caves and subterranean environments so that one can at least be able to find out where the passageways, tunnels, shafts or connecting structures are located relative to the surface of the earth.

Once having appropriately mapped a subterranean environment, there is then a need to be able to find out the position of individuals or objects within the subterranean environment based on the accurate mapping so that in the case of an emergency help can be directed to the exact area in which a dangerous condition or accident exists. This would, for instance, enable the penetration of the affected area with precisely drilled air holes such that miners caught underground could survive until help arrives.

Moreover, while it is sometimes possible to be able to ascertain that an accident has occurred and, for instance, a fire has caused an explosion, for instance of methane gas, there is a need to know how the explosion will propagate in the subterranean environment.

Note that electromagnetic waves have both an electric E-field and a magnetic H-field in which the electric field and the magnetic field are orthogonal to each other, with electromagnetic energy alternating between the two. For most HF and VHF communication purposes, the E-field and the H-field are tightly coupled such that if the E-field is grounded as, for instance, by attempting to penetrate the earth, the H-field at these frequencies is likewise heavily attenuated.

For instance, if one has an electric field antenna such as a wire, as soon as one goes underground, the electric field of any surface electromagnetic transmission disappears within centimeters from the surface of the ground. The ground is conductive enough so that even if the ground has a conductivity of mega-ohms, the electric field is nonetheless rapidly dissipated.

### SUMMARY OF INVENTION

It has been found that low frequency electromagnetic radiation, such as that associated with LORAN navigation systems at 100 KHz, has an H-field (magnetic) component that is not significantly attenuated as one goes below the surface of the earth. At these low frequencies, it turns out there is very loose coupling between the E-field and the H-field. It has been found that while the E-field for such low-frequency transmissions is attenuated at the surface of the earth, the H-field or magnetic field component of the electromagnetic wave is only slightly attenuated by the earth and will propagate at least one-half wavelength. At the LORAN frequencies, this means that it can propagate a statute mile down into the earth.

It has also been found that with LORAN stations even many thousands of miles away from the subterranean location, the LORAN signals are detectable in the subterranean environment by means of using an H-field antenna, one instance of which is simply a coil of wire. Since electricity when passed through a coil produces a magnetic field, conversely an alternating magnetic field will produce an electric voltage and current within the wire.

It has been found that signal-to-noise ratio improves as one goes deeper under ground. This being the case, one can take a conventional LORAN receiver and connect it to an H-field antenna in a subterranean environment and have lockup times that are faster than those associated with LORAN receivers above ground.

The reason that one can receive the LORAN signals in a subterranean environment as far as one mile beneath the surface of the earth is because of the low frequency of the LORAN signals, coupled with the fact that there is little attenuation of the magnetic fields as opposed to the electric fields.

It is common knowledge that ground has a very low magnetic permeability, unlike steel or magnets, such that there is little in the rock and the soil that would attenuate the magnetic field component of an electromagnetic wave.

Note that in HF communications there is a rule of thumb that for up to one-half wavelength one does not obtain much attenuation.

If this were applied to low-frequency magnetic field components, this would mean a range of a statute mile as mentioned above.

However, there is another characteristic of the LORAN signal making it detectable in a subterranean environment for even better than one-half wavelength. This is the intentional repetition of the data bits in a group, which is used for processing gain. The LORAN coding repeats itself many times per second, resulting in tremendous signal processing gain as the signal is repeated over and over within the same time frame. Thus, while the rule of thumb of half wavelength applies to signals such as voice and coded messages that are not typically repeated, the half wavelength rule does not necessarily apply to LORAN signals due to the repetition of the cycles and integration over long periods of time.

The discovery of the ability to obtain terrestrially generated LORAN signals beneath the surface of the earth was made in two steps. First it was proved that the LORAN signal penetrated the Earth by using an AM receiver with an H Field antenna. If one demodulates the AM LORAN signal to audio, one hears a characteristic audio hash or chirping. When such a receiver was carried down 50 to 150 feet below the surface of the earth, the LORAN modulation was audibly heard even without sophisticated signal processing techniques. The success of this first step led to the successful second step in which a conventional LORAN receiver was used at the same underground positions to obtain time differences. Thus the hyperbolic lines of position (LOP) that are typically used above ground were available underground.

Moreover, presently LORAN-C has now been converted to E-LORAN systems in which every slave and every master has an atomic clock. With every slave and every master having an atomic clock, there is almost universal coverage above the equator. Thus, while LORAN-C had a requirement of hearing the master, hearing any three slaves in E-LORAN now significantly extends coverage.

Thus, to map a mine, cave or any subterranean environment, one need not do anything other than use an H-field antenna and a commercial LORAN receiver with an H-Field antenna underground to be able to map the entire subterranean structure using the usual time difference LORAN LOP grids that exist underground. Moreover, the mapping is exceedingly accurate due the repeatability that is associated with the LORAN system.

In one embodiment, for absolute positional accuracy one would simply get a GPS fix at the mouth of a cave or mine and then a LORAN fix, with the difference being an offset that could be applied to all of the LORAN readings in the subterranean environment.

As is common with LORAN navigation and mapping, the hyperbolic coordinate conversions are from sets of three transmitters whose locations on the surface of the earth are known. Modem LORAN receivers will track 10 to 14 LORAN transmitters simultaneously and have statistical averaging techniques to come up with the best possible position solution. While E-LORAN might have an absolute accuracy of 40 feet, repeatability accuracy is in the 1-foot range. Thus, present E-LORAN systems can be used in any subterranean environment, since one can use the existing LORAN transmitters. This is because one can now use E-LORAN and use any mixture of slaves that are detectable to get good positioning virtually anywhere North of the equator. What this now means is that absolute positional accuracy is now available due to LORAN-repeatability accuracy and use of the aforementioned offsets.

LORAN stations provide the ability to navigate subterranean environments while permitting exceedingly accurate mapping where none has been available. These same LORAN stations also provide a heretofore-unknown means of communication to and from the individuals in the subterranean environment.

As is well known, each LORAN slave or master creates its own identity by utilizing an inserted digital code that is repeated many times, usually using extra bits at the end of a LORAN “sentence.” By using a digital modulation scheme and altering these bits, one can provide a text message to the LORAN receiver in the subterranean environment. Thus, communication from the surface to the subterranean environment is made possible regardless of any pre-existing communications equipment, typically hard wired, that may be in the mine, cave or subterranean location.

As a result, in a mine accident where hard wired communications are often disabled by the accident, it would be possible to communicate directly with the miners through modulation of the LORAN transmissions so that they could know when help was coming.

Moreover, by using a simple low-frequency transmitter and an H-field antenna, one can communicate with the surface of the earth using an underground low-frequency handheld communicator of on the order of one watt. This is accomplished by modulating the H-field that is only moderately attenuated as it goes up to the surface of the earth. The ability of a handheld transmitter to transmit to the surface of the earth provides the ability for those at the surface of the earth to know the location of the individual who has previously demodulated and received the LORAN signals at his or her location. It is also possible to provide this handheld low-frequency, one-watt communicator with additional modulation capability in which the modulation is digitally encoded and is transmitted by the modulated H-field through the ground to the surface of the earth, where another H-field antenna is utilized with a suitable receiver.

Communication from LORAN towers to the subterranean receiver is made possible by the aforementioned processing gain due to the repetition of the LORAN signals. Likewise, one utilizes message repetition techniques to transmit subterranean information so that the similar processing gain works to permit low-power communications to be heard at the surface of the earth.

Moreover, in experiments dealing with the ability to receive LORAN signals in a subterranean environment, it has been found that the signal-to-noise ratio increases as one goes deeper and deeper into the earth. Additionally, the lockup times or times to first fix of the LORAN receivers are much shortened. For instance, in one test it has been found that a surface signal-to-noise ratio of 33 is increased to 79 at a depth of 50 feet and to 81 at a depth of 150 feet.

One plausible explanation for the increase in signal-to-noise ratio and decrease of lockup times is that if one considers that on the surface of the earth one may have two sources of radio energy, one at frequency F₁ and one at frequency F₂. One can see both the energy at F₁ from the first transmitter and the energy F₂ from a second transmitter so that one will see the energy at F₁+F₂ and F₁−F₂. However, if one places the frequency of F₂ just below the frequency of F₁, then if one selects to detect the sum of the two frequencies and provide a cutoff filter for only the low-frequency component, then one has in essence an AM radio. Since there are millions of such transmitters whose frequency is only 100 KHz away from another, then it is clear that every pair of these transmitters creates noise in the LORAN bandwidth. These are, however, at much higher frequencies, like 1 GHz+100 KHz.

As mentioned before, these higher frequencies have considerable coupling between the E-fields and the H-fields. As a result, these noise signals do not penetrate the ground. Since these noise signals do not penetrate the ground, the LORAN signal-to-noise ratio increases as one descends into the ground, with the LORAN lockup times dropping as well. Moreover, repeatable accuracy improves due to the elimination of the surface noise.

It has also been found that while large coils such as 3 feet in diameter can be utilized, the minimum antenna size that one could use would be about 1 inch core of high magnetic-permeability antenna material wrapped with multiple turns of wire.

It has also been found that one must have a two-axis H-field antenna because of the positive and negative pulses that are generated during the LORAN transmission. If one were to have only one H-field antenna and no orthogonally oriented second antenna, one can wind up with what is known as a half-cycle error. The reason is as follows.

The E-field portion of the LORAN transmission always works above ground because one has the receiver underneath the antenna. The antenna is therefore always pointed up. If it were the other way around with the receiver on top of the antenna and the antenna pointed down, the coded LORAN waves being positive and negative would be received as being reversed or inverted. Thus, LORAN transmissions are polarized and the effect is that a LORAN receiver could get confused as to whether a positively coded pulse was a negatively coded pulse due to antenna polarization and orientation.

Coding is important because when the LORAN transmitter transmits, it identifies itself by the coding of these pulses. For instance, a master might have the following coding: positive, positive, negative, negative, positive, negative, positive, negative, positive (group A). The LORAN master then waits a predetermined time interval and then re-transmits this group again.

On the other hand, the slaves have different coding, though both positive- and negative-going bits.

Normal LORAN receivers listen to enough of the pulse trains to figure out the identity of the master or slave based on positive polarization of the antenna, on the assumption that the receiver is on the bottom of the antenna. If the receiver is on the top of the antenna, the polarity is reversed because the LORAN wave is a polarized wave.

On the other hand, in the subterranean environment, one requires orthogonal H-field antennas because they are directional. The magnetic field in the subterranean environment is horizontal and if one has a coil of wire lying in a vertical plane, the polarization to one side will be opposite the other side of the coil. Thus the received LORAN bits will be plus or minus depending on which side of the coil the H-field wave is coming in on.

Thus, all H-field antennas inherently have polarization. Of course, all E-field antennas also have polarization, but if one is looking for an audio signal it would not make any difference whether the wave is inverted or not because one is only interested in the frequency component. However, in LORAN, one is interested in the zero crossovers of the various waves as opposed to the amplitude, such that if one put a positively coded wave or pulse on one side of the antenna, if the LORAN receiver was on the positive side, the receiver would see a positive-coded pulse. However, if one puts the positive-coded pulse into the negative side of the H-field antenna, it is received as a negatively coded pulse. By utilizing two orthogonal H-field antennas and software within the receiver, one can unambiguously decide whether the pulses are negative or positive. Such a receiver is commercially available.

There is an unintentional side effect of using orthogonal antennas because one can determine the location of the transmitters and by so doing one can have a geodetic compass. Knowing where the transmitters are, one can figure out based on the polarity of the signal where geodetic (true) north is.

It is noted that if one did not utilize orthogonal H-field antennas, due to the uncertainty of whether a pulse is positive or negative, one can have a half-cycle error. This error would typically occur in the tracking circuitry that measures the third zero crossing of the LORAN wave. If the receiver thinks that the pulse is positive and it is really negative, when one looks at the third zero crossing, one actually detects the wrong crossing by five microseconds. This, of course, is a huge tracking error. However, in the subject system, the dual or orthogonal-axis antenna permits ascertaining which pulses should be inverted and which ones should remain the same so that one can eliminate the H-field antenna polarization problem.

While the H-field polarization problem is known and its solution is known, heretofore what has not been understood is that the entire system could work in a subterranean environment.

In summary, a system is provided for underground mapping, location determination and communications utilizing existing LORAN transmitters and a subterranean H-field antenna coupled to a conventional LORAN receiver. The result is an underground LORAN grid from which mapping and location can be ascertained as well as terrestrial-to-subterranean communications using the LORAN bit streams.

Subterranean-to-terrestrial communication is established by a low-frequency handheld transmitter using repeat processing to transmit digital data from the subterranean location to the surface of the earth using modulated H-field waves.

Should LORAN become unavailable, lower-power systems could be utilized where transmitters are placed close to the desired mapping site and used in lieu of the LORAN transmitters. This would also support bidirectional communication.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of a miner in an underground passage whose position can be determined by using existing LORAN transmitters, with the H-field propagation to the subterranean point at which the miner exists permitting the location of the miner based on LORAN time differences;

FIG. 2 is a diagrammatic illustration of a top view of the mine shaft of FIG. 1, illustrating that the LORAN grid time difference hyperbolic lines of navigation exist in a horizontal plane bisecting the miner's underground position such that by utilizing conventional LORAN transmitters and receivers, one can develop a subterranean map that can be referenced to the surface in order to provide accurate location not only of the subterranean features but also of an individual or object in the subterranean location;

FIG. 3 is a diagrammatic illustration of one embodiment of the subject invention in which a master and slaves transmit detectable H-field signals in a mine shaft such that a pre-amplified H-field antenna coupled to repeat processing permits a LORAN receiver to display the LORAN coordinates as well as any LORAN text message, the output of the LORAN receiver being coupled to a low-frequency transmitter coupled to an H-field antenna such that the location of the first H-field antenna can be transmitted by low-frequency H-field waves to a local receiver on the surface of the earth, also illustrating modulation of the low-power transmitter to provide other data related to a subterranean individual or object;

FIG. 4 is a block diagram of the test system used to authenticate the fact that one could obtain LORAN fixes in a subterranean environment, illustrating the use of an H-field two-axis loop antenna with a pre-amp coupled to a handheld LORAN receiver that outputs NMEA-0183 data to a data logger to indicate position of the subterranean receiver;

FIG. 5 is a graph showing longitude and latitude of a LORAN receiver as a function of time when 50 feet underground;

FIG. 6 is a graph showing latitude and longitude as a function of time, indicating standard deviations in latitude of 11.9 feet and in longitude of 39.8 feet;

FIG. 7 is a diagrammatic illustration of the polarity of a loop antenna, viewing antenna gain from the top of the loop;

FIGS. 8A, 8B and 8C illustrate how the LORAN coding gets reversed due to the polarity of the loop antenna in which a loop antenna in FIG. 8A has a positive lobe into which positively-coded pulses are injected, with the received signal outputting a positively coded pulse as illustrated in FIG. 8C;

In FIGS. 9A, 9B and 9C, the loop antenna of FIG. 8A is illustrated in which a negative lobe has a positively-coded pulse of injected into it, with the result being a negatively coded pulse as a the result of the positively-coded pulse entering the negative lobe of the loop antenna;

FIG. 10 is a diagrammatic illustration showing a master and slave to one side of the loop antenna and another slave to the other side of the loop antenna in which the signals from master and slave to one side of the loop antenna are correctly coded, whereas the signals from the slave on the other side of the loop antenna are coded as being inverted;

FIG. 11 is a diagrammatic illustration of the 5-microsecond error as a result of the zero crossings for correct pulse coding versus non-correct pulse coding, which if the inverted signals are not corrected, result in large positional errors;

FIG. 12 is a diagrammatic illustration of the increase of signal-to-noise ratio as one goes deeper and deeper underground when detecting the H-field component of a LORAN signal; and,

FIG. 13 is a diagrammatic illustration of the use of high magnetic permeability slugs overwound with coils to provide orthogonal miniature H-field antennas for use in the subject invention.

### DETAILED DESCRIPTION

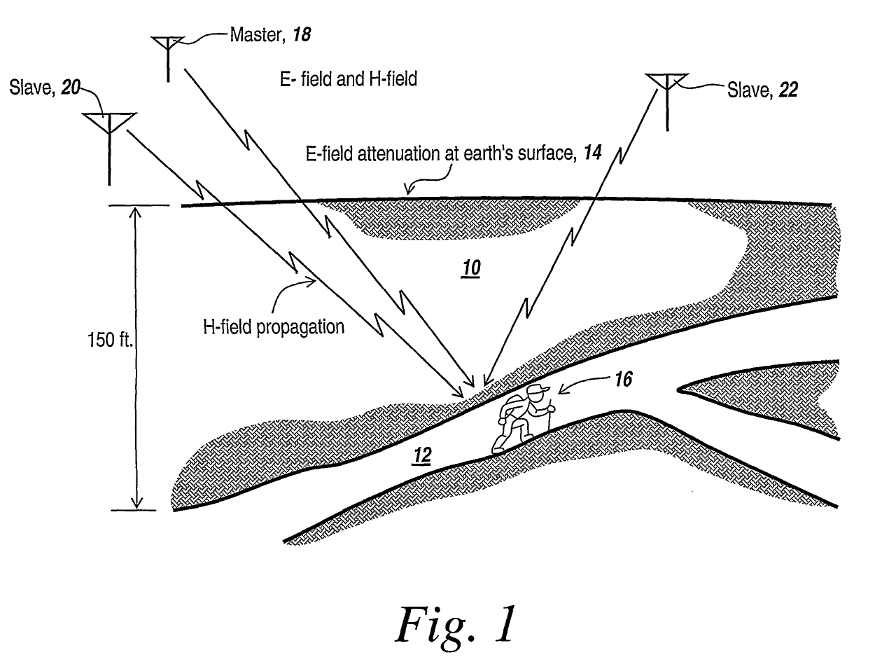

Referring now to FIG. 1, what is depicted is a subterranean environment 10 in which a subterranean passageway, tunnel or the like 12 is shown depicted some 150 feet below the surface 14 of the earth. Also depicted in passageway 12 is an individual 16, who may be a miner, a spelunker or any individual that is on a subterranean mission.

One of the problems has been the ability to map the subterranean environment so as to know the exact position of the passageways, tunnels or corridors relative to the earth's surface.

It has been found that subterranean positions can be accurately ascertained as much as a mile underground by receiving the standard LORAN transmissions from, for instance, a master 18 and slaves 20 and 22. The masters and slaves in a LORAN-C system, or more importantly the slaves in an E-LORAN system, are positioned at known positions on the surface of the earth and have terrestrial coverage now north of the equator, at least in the North American continent. The masters and slaves have anywhere from a quarter of a megawatt to a megawatt in transmitting power and radiate signals in the 100 KHz band.

The radiation includes both an E-field and an H-field. When the E-field signals from the faraway master and slaves or from the slaves reach the surface of the earth, they are attenuated to zero a couple of centimeters below the surface of the earth. For conventional LORAN receivers, this means that the signals are not detectable beneath the surface of the earth. The reason is that the E-field component of the wave is attenuated at the earth's surface due to the grounding provided by soil and rock.

However, it is a finding of the subject invention that due to the low frequency of the transmission and the loose coupling of the E-field and H-field that occurs at 100 KHz, the H-field component of the transmitted wave propagates well below the surface of the earth. This is because there is in general magnetic field is not heavily attenuated by material in the subterranean environment.

It has been found that it is possible to detect the LORAN signals at, for instance, the position where individual 16 is located beneath the surface of the earth.

Thus it is the H-field propagation that permits mapping of the subterranean structure including subterranean caverns, mineshafts, passageways and corridors, which heretofore has been difficult due to difficulties in dead reckoning.

Moreover, since it has been found that H-field propagation is sufficient to lock up a LORAN receiver coupled to an H-field antenna, for instance, to locate individual 16 within a matter of feet.

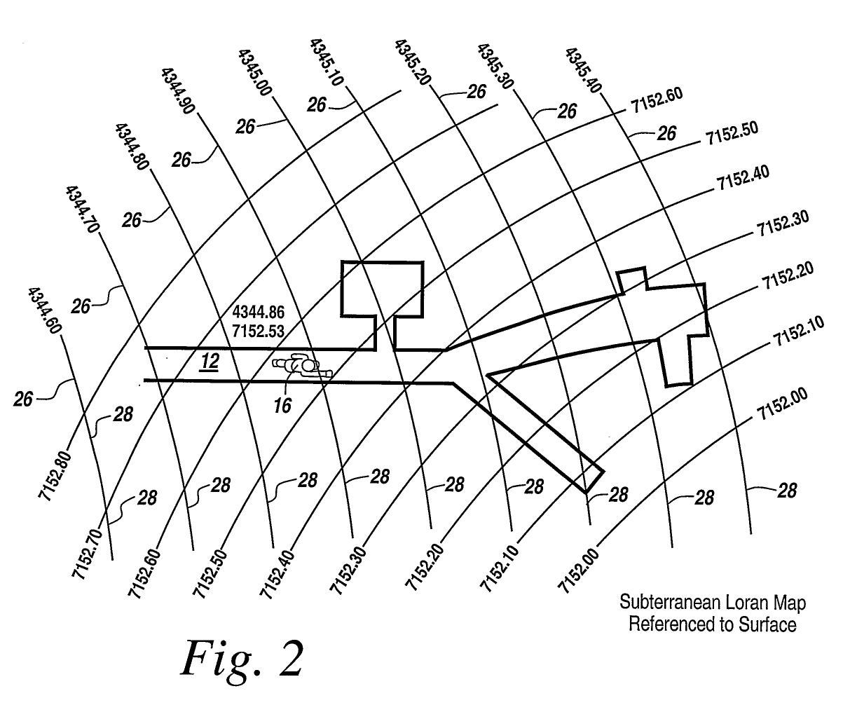

Referring now to FIG. 2, passageway 12 is shown overlain with a grid of the time difference plots from two slaves or a master and slave, such that one set of time differences is indicated by the set of lines 26, whereas a different set of time difference lines 28 cross lines 26.

In this case, the time differences associated with lines 26 are 4344.80, 4344.90 and 4345.00.

On the other hand, the crossing time differences associated with lines 28 are 7152.80, 7152.70, 7152.60 and 7152.50. Note that these time difference lines of position (LOP) permit locating an object or a person relative to two sets of crossing lines, with individual 16 being found to be located at 4344.86; 7152.53.

Thus, what is shown in FIG. 2 is a subterranean LORAN map referenced to the surface, which uniquely specifies the location of all the subterranean features as well as, for instance, objects or individuals within passageways, tunnels and the like.

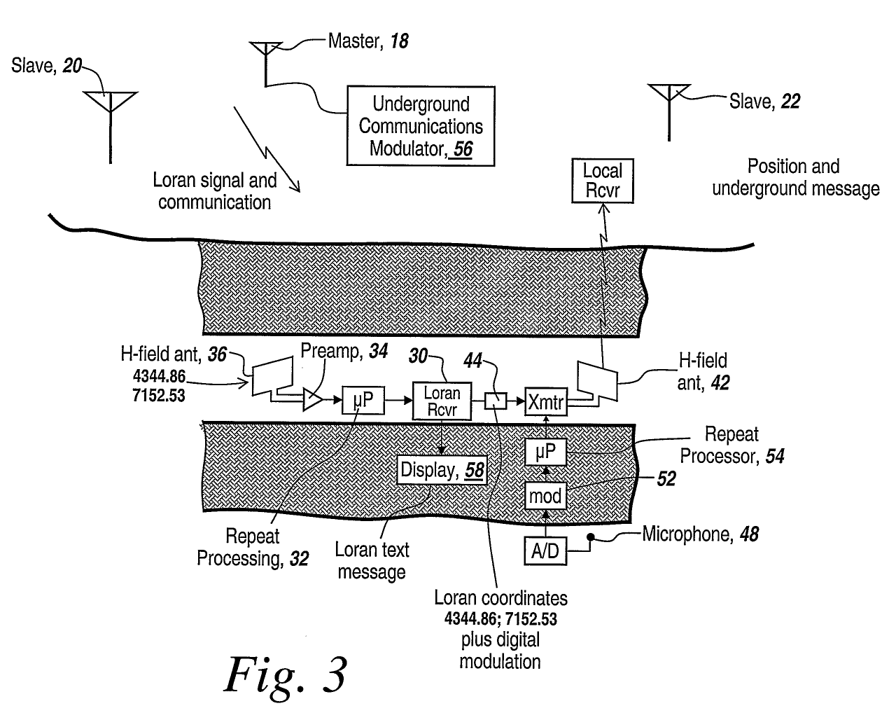

Referring now to FIG. 3, what is shown is a LORAN receiver 30 coupled to a repeat processing unit 32, which is coupled to a pre-amplifier 34, in turn coupled to the output of an H-field antenna 36. Note that LORAN receiver 30 is provided with a display 38, which displays, inter alia, the LORAN coordinates of the particular position of H-field antenna 36 and can, for instance, display messages that are encoded into the LORAN transmissions from the LORAN transmitters. LORAN receiver 30 outputs coordinates 4344.86 and 7152.53, in one embodiment to a low-frequency transmitter 40 coupled to its own H-field antenna 42. Here for processing gain a repeat processing module 44 takes the LORAN coordinate data and repeats it many times per second in much the same way that LORAN signals are modulated with data at the masters and slaves. This frequently repeated LORAN coordinate data is transmitted from H-field antenna 42 to a local receiver 44, which has its own H-field antenna such that the subterranean position of H-field antenna 36 may be made known at the surface of the earth.

In order to provide more information other than the LORAN coordinates of H-field antenna 36, it is possible to provide a microphone 48 coupled to an analog-to-digital converter 50, which is in turn coupled to a modulator 52, in turn coupled to a repeat processor 54, which repeats short digital sentences, again for processing gain, so that the condition of an individual or object in a subterranean environment can be ascertained at the surface of the earth.

What will be appreciated is that the communications system, both of transmitting LORAN signals to a subterranean environment and coupling digitally modulated low-frequency signals out of a subterranean environment is done through H-field propagation techniques in which the E-field components, although they are attenuated, do not affect the magnetic wave communications system.

As seen in FIG. 3, it is also possible for a LORAN transmitter to have an underground communications modulator 56 whose digital messages are encoded in the LORAN string so that not only is the LORAN signal communicated to the subterranean environment, messages in addition to the identity of the master or slave are also capable of being transmitted to an individual underground so that he may receive signals from the surface of the earth. These messages may be displayed on display 38 as a LORAN text message. It is therefore possible to inform individuals at risk underground what is being done to rescue them by communicating to them via this low-frequency H-field technique.

Likewise, the position of an individual or object underground along with his or its condition can be transmitted to the surface of the earth, again by H-field techniques and low-frequency signals that have been shown to penetrate the earth regardless of E-field attenuations. It is therefore possible for an individual carrying a conventional handheld LORAN receiver coupled to a miniature H-field antenna to pick up his or her position in the subterranean environment and to transmit it, again using H-field techniques, to the surface of the earth with as little as one watt.

Thus it is possible at the surface of the earth to receive the position of a stricken individual and his condition utilizing the repeat processors for the aforementioned processing gain.

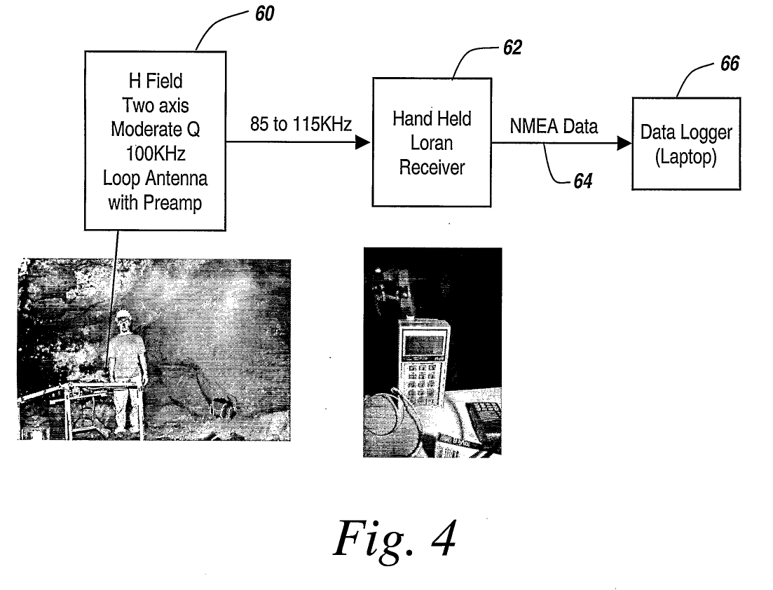

Referring to FIG. 4, the test system utilized to confirm the existence and detectability of terrestrial LORAN signals in a subterranean environment includes a two-axis Moderate-Q H-field loop antenna with pre-amp, here illustrated at 60. In this case the two-axis H-field antenna involved a number of turns of wire in a square of PVC pipe, with about three feet on a side.

The output of the two-axis H-field antenna was between 85 and 115 KHz in bandwidth, which was coupled to a handheld LORAN receiver 62 that in one embodiment was a PL-99 receiver having an NMEA-0183 data output, illustrated as 64. This output was coupled to a laptop data logger 66. While the PL-99 LORAN receiver was not capable of disambiguating polarity in inversions of the LORAN signals, H-field LORAN receivers that do so are commercially available.

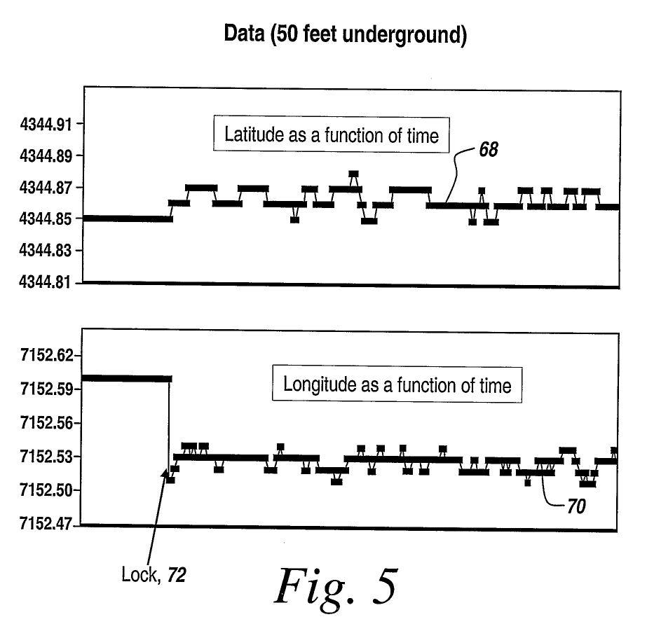

Referring to FIG. 5, detected latitude and longitude as a function of time is graphed, respectively by lines 68 and 70, with the data points indicated by the squares on the indicated lines. Note that subterranean lock was achieved as illustrated at 72, with the time to first fix, as will be described, much faster than that associated with terrestrial operation.

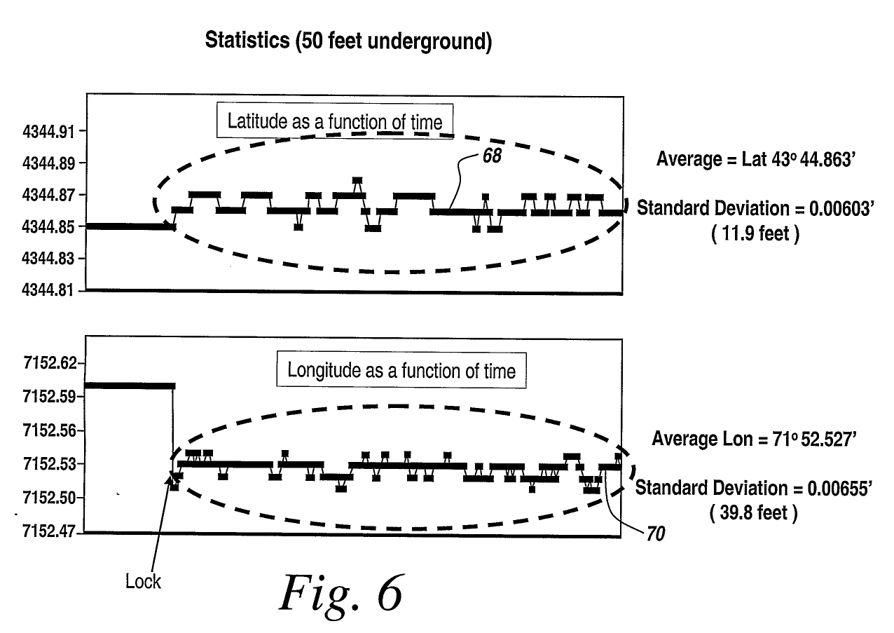

Referring to FIG. 6, for 50 feet underground the average latitude was calculated and, the standard deviation was found to be 11.9 feet in terms of absolute positional accuracy. Likewise, averaging the longitude and using the same standard deviation techniques, the standard deviation for longitude in absolute terms was found to be 39.8 feet.

It will be appreciated that absolute accuracy is not as important as repeatability, as it is well known that LORAN hyperbolic lines of position do not vary over the surface of the earth and likewise have been found not to vary in the subterranean environment.

As explained hereinbefore, for absolute positional accuracy LORAN positions can be referenced to a GPS-determined point on the surface of the earth, for instance at the entrance of a cave or mine. Thereafter the difference in detected position, and an offset derived from a LORAN receiver at the same position from that read out of the GPS receiver results in an offset that can be applied across the subterranean territory of interest.

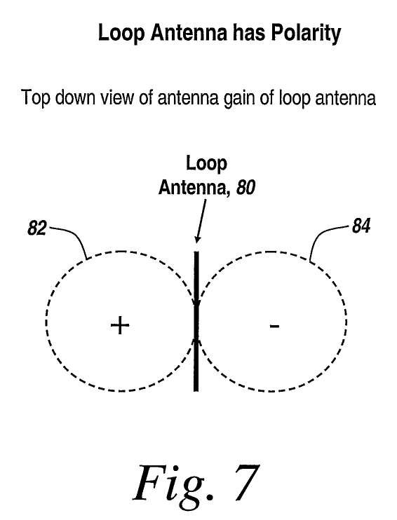

Referring now to FIG. 7, in terms of H-field antennas, a loop antenna 80 is shown in a top-down view to have polarity in which a lobe 82 to the left of the antenna loop is designated with a positive polarity, whereas a lobe 84 to the right of the loop is designated as having a negative polarity.

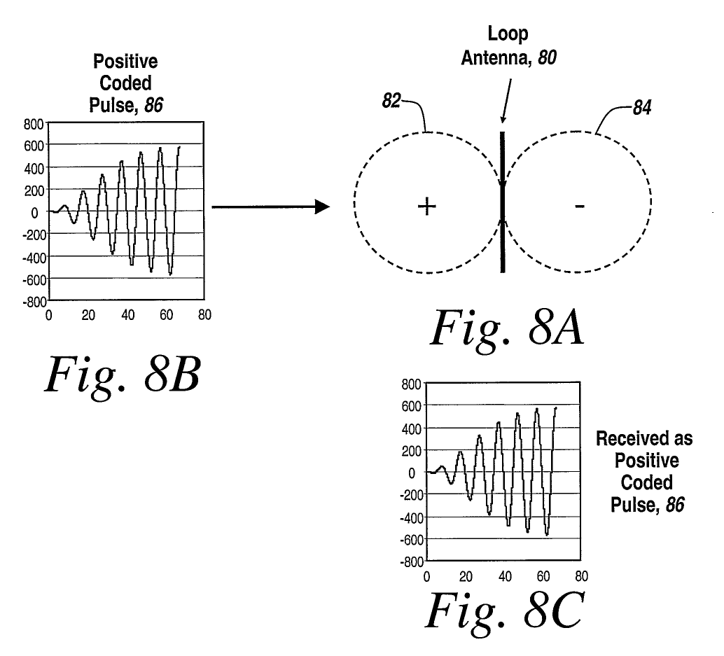

Referring to FIGS. 8A, 8B and 8C, for loop antenna 80 and the indicated polarities 82 and 84, for a positively coded pulse 86 coming in on lobe 82, which is the positive polarization for the loop antenna, a positively coded received pulse 88 is identical in amplitude and polarity to the positively transmitted coded pulse coming in on lobe 82 as illustrated in FIG. 8C.

However, as illustrated in FIGS. 9A, 9B and 9C, positively coded pulse 86 enters antenna 80 through negative lobe 84. The result, however, is shown at 88 as a negatively coded received pulse, which means that the orientation of the antenna and its lobes are critical as to whether the received pulse is inverted or not.

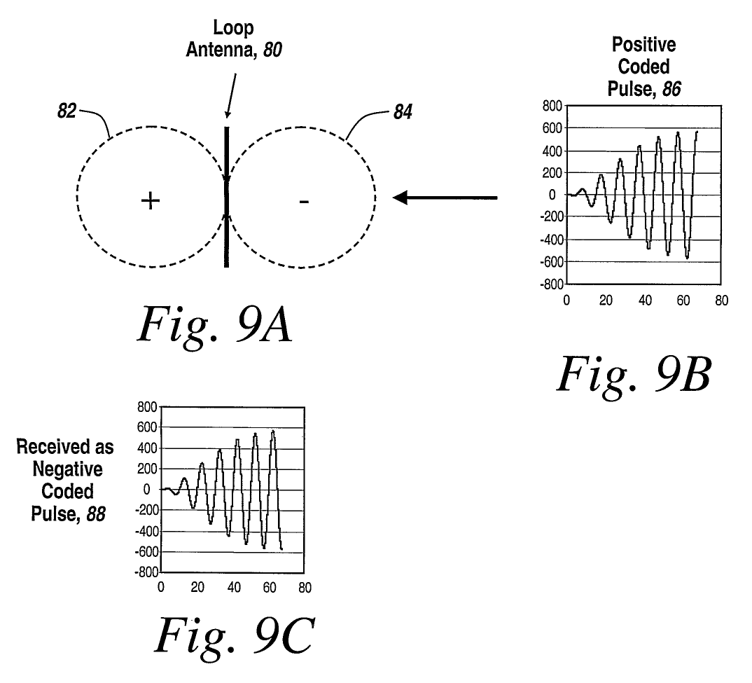

As illustrated in FIG. 10, a master and slave, respectively at 90 and 92, are to the left of loop antenna 80. Therefore signals from the master and slave are correctly coded. However, for a slave 94 whose signals come through negative lobe 84, the signals are detected as having their coding inverted.

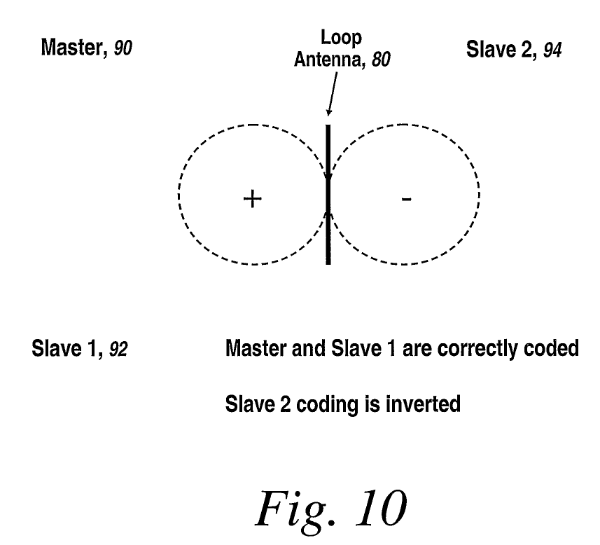

Referring now to FIG. 11, the result of the inversion of signals can induce a half-cycle error. This can be seen by viewing the correct pulse coding 96 and the inverted pulse coding 98 such that between the two corresponding portions of the wave, there is a 5-microsecond error 100 in detected zero crossing.

Thus, LORAN signals that come in on the negative lobe part of the antenna pattern have their pulses inverted. Even though the power envelope is correct, the signal still exhibits the above-mentioned inversion.

Most LORAN receivers select the third zero crossover for time difference determination. However, for half-cycle skipping it as can be seen that the zero crossover is precisely at 5 microseconds from where it should be. It is noted that the more modern H-field LORAN receivers correct for this problem through software.

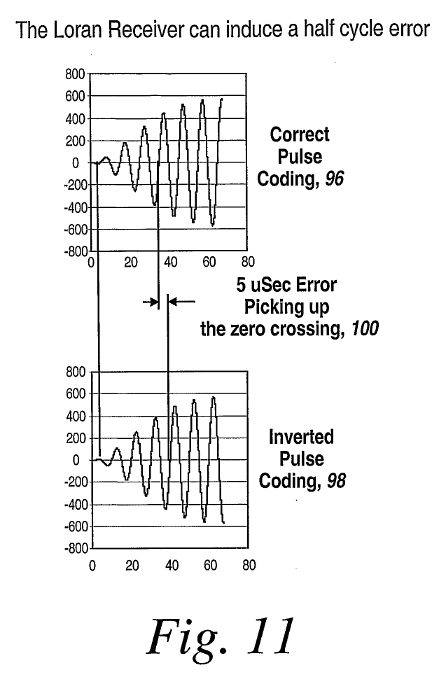

Referring now to FIG. 12, it is a property of the subject system that the signal-to-noise ratio improves as one descends into the subterranean environment. Here it can be seen that at the surface of the earth 102 the signal-to-noise ratio was found to be 33, whereas at 50 feet below the earth in a subterranean cavern 104, the signal-to-noise ratio was found to be 79. Moreover, at a point in tunnel 106 150 feet below the surface of the earth, the signal-to-noise ratio was 81.

The reason that the signal-to-noise ratio improves and in fact the lockup times decrease is because much of the terrestrial-based noise is completely eliminated through E-field grounding of the higher-frequency signals.

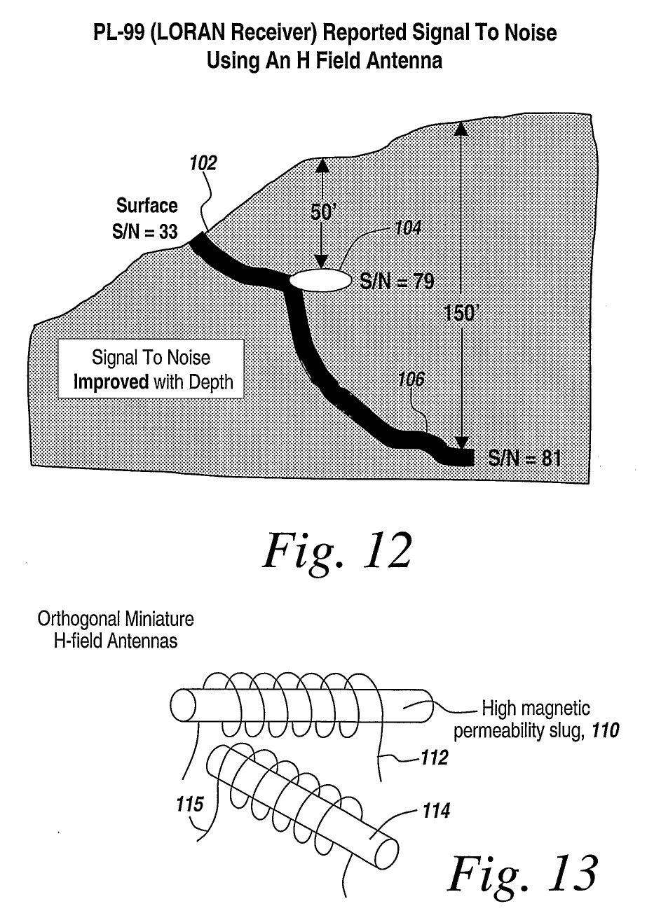

Referring now to FIG. 13, in order to collapse the H-field antennas down to an inch or two, one can use a high magnetic permeability slug 110 surrounded by, for instance, 200 turns of coil 112; and that one can have an orthogonally oriented miniature antenna as illustrated by slug 114 and coil 116 such that suitable input to a LORAN receiver can be provided.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for determining subterranean location, comprising the steps of:
detecting LORAN signals in the subterranean location, the signals having been transmitted by LORAN transmitting stations; and,
indicating the subterranean location from the detected LORAN signals.

2. The method of claim 1, wherein the detecting step includes the step of detecting the magnetic field component of the electromagnetic waves from the LORAN transmitting stations.

3. The method of claim 2, wherein the detecting step includes the step of coupling an H-field antenna to a LORAN receiver.

4. The method of claim 3, and further including the step of communicating the detected subterranean LORAN location to the surface of the earth.

5. The method of claim 4, wherein the communicating step includes the step of communicating the detected LORAN location by means of low-frequency signals transmitted from the subterranean location to the surface of the earth.

6. The method of claim 5, wherein the low-frequency signals include LORAN frequency signals.

7. The method of claim 5, wherein the communicating step includes generation of digital low-frequency signals.

8. The method of claim 7, wherein the communicating step includes the step of repeating the digital signals to permit processing gain.

9. The method of claim 7, wherein the communicating step includes the step of communicating information other than detected LORAN location to the surface of the earth.

10. The method of claim 9, wherein said other communication includes the generation of digital low-frequency signals.

11. The method of claim 10, wherein the digital low-frequency signals containing information other than subterranean location are taken from the group consisting of health of an individual, condition of an individual, parameters relating to an object at the subterranean location, conditions surrounding the subterranean location, voice messages and text messages.

12. The method of claim 11, wherein the communicating step includes the step of repeating the digital signals to permit processing gain.

13. The method of claim 5, wherein the communicating step includes utilizing a low-frequency transmitter and an H-field antenna coupled thereto.

14. The method of claim 1, and further including the step of communicating information from the surface of the earth to the subterranean location by modulating the LORAN signals.

15. The method of claim 14, wherein the step of modulating the LORAN signals includes the step of altering bits of the digital LORAN signal pulse train.

16. The method of claim 14, and further including the step of displaying the information contained on the modulated LORAN signals at the subterranean location, whereby terrestrial messages can be transmitted to the subterranean location without the use of pre-existing communicating equipment at the subterranean location.

17. The method of claim 1, and further including the step of collecting the indicated subterranean location from the detected LORAN signals; and, mapping the structure of the subterranean location based on the collected information, whereby accurate maps of the subterranean structure can be created.

18. The method of claim 17, wherein the subterranean location has an entrance at the surface of the earth, and further including the step of ascertaining from the entrance the accurate position of the entrance; taking a LORAN location reading at the entrance; calculating an offset between the accurate location of the entrance and the LORAN-derived location; and, correcting the detected LORAN signals at the subterranean location utilizing the offset, whereby accurate subterranean location indications can be achieved due to the repeatability of LORAN location determination.

19. The method of claim 1, and further including the step of locating the LORAN transmitting stations adjacent the subterranean location.

20. A method of communicating between the surface of the earth and a subterranean location, comprising the steps of:
generating a modulated digital signal at a low frequency having informational content; and,
transmitting the modulated signal through the earth.

21. The method of claim 20, wherein the digital modulated signal is repeated for processing gain.

22. The method of claim 20, wherein the low frequency of the communication is in the LORAN frequency band.

23. The method of claim 20, wherein the transmitting step includes the step of transmitting both E-field and H-field components of an electromagnetic wave, and further including the step of receiving the H-field components that travel through the earth utilizing an H-field antenna coupled to a receiver capable of detecting and demodulating the modulated low-frequency signals.

24. The method of claim 20, and further including the step of using a LORAN transmitter at the surface of the earth in the transmission of the modulated information and utilizing a subterranean receiver for receipt of the signals from the LORAN transmitter, the receiver coupled to an H-field antenna and outputting the modulated information at the subterranean location.

25. The method of claim 20, and further including the step of providing a low-frequency transmitter at a subterranean location connected to an H-field antenna and digitally modulating the transmitter at the subterranean location with information to be transmitted through the earth to the surface of the earth.

26. The method of claim 25, and further including the step of providing an H-field antenna and low-frequency receiver at the surface of the earth for detecting the modulated information from the subterranean transmitter.

27. A method for mapping a subterranean structure, comprising the steps of:
detecting LORAN signals at subterranean locations;
storing the locations; and,
creating a map based on the stored locations.

28. The method of claim 27, and further including the step of ascertaining the coordinates of an entrance to the subterranean structure; determining the LORAN coordinates of the entrance; generating an offset between the ascertained coordinates of the entrance and the position of the entrance indicated by the LORAN coordinates; and, using the offset to offset LORAN-derived subterranean locations.

29. The method of claim 28, wherein the ascertained coordinates of the entrance include GPS coordinates.
